(19) United States
(12) Patent Application Publication
(10) Pub. No.: US 2013/0339184 A1
(43) Pub. Date: Dec. 19, 2013

(54) Method and System For Selling Items To Be Worn

(71) Applicants: Nadia Shouraboura, Seattle, WA (US); Caroline Jacqueline Shouraboura, Seattle, WA (US)

(72) Inventors: Nadia Shouraboura, Seattle, WA (US); Caroline Jacqueline Shouraboura, Seattle, WA (US)

(21) Appl. No.: 13/918,937

(22) Filed: Jun. 15, 2013

Related U.S. Application Data
(60) Provisional application No. 61/660,767, filed on Jun. 17, 2012.
(60) Provisional application No. 61/819,570, filed on May 4, 2013.
(60) Provisional application No. 61/660,767, filed on Jun. 17, 2012.

(51) Int. Cl. G06Q 30/06

(52) U.S. Cl. CPC G06Q 30/0639
USPC 705/26.8; 705/26.9

(57) ABSTRACT

Embodiments of the disclosed technology relate to systems and methods for beginning and completing a physical store transaction for an item, or items, to be worn. The transaction is directed by a purchaser using in-store indicators, conveyance windows, electronic devices, and/or by an act of moving unique identifiers, attached to items to be worn, electronic devices or the purchaser.

The computing system associates electronic identifiers with products, directs storage of products within store inventory holding locations, receives purchaser's requests, directs retrieval and movement of products to store locations where they may be examined and tried by purchasers, and/or completes purchase transactions.

The purchaser may complete the buying of the product by walking to the store, taking the item he/she needs and walking out of the store with no additional action (zero-action).

### CROSS-REFERENCE TO RELATED APPLICATIONS

This application claims the benefit of U.S. Provisional Application No. 61/660,767, filed Jun. 17, 2012 and also claims the benefit of U.S. Provisional Application No. 61/819,570, filed May 4, 2013.

### BACKGROUND

The disclosed technology is in the technical field of selling items to be worn.

Purchase decisions for items to be worn (“apparel”) today are made either on-line, over the internet (“e-commerce”), or in physical stores (“bricks and mortar”). Purchasing of apparel and other items to be worn, at bricks and mortar retailers, is deficient for both the retailer and the customer. The bricks and mortar retailer must manage a chaotic shop floor inventory and their customers must suffer through an inefficient process of finding and trying on the apparel items they desire.

Retailers place apparel items for sale on shelves, hangers, or other presentation locations within the retail store where they are selected for purchase by the customer. Once an item has been placed on the retail shop floor its precise location is no longer known. Items may be moved by customers or employees. Retail store owners may suffer “shrinkage”, inventory which is lost through theft as employees can remove inventory through the back door.

Because locations on the shop floor must be optimized for display to the customer, the use of retail store space cannot be optimized. Product selection is an important customer satisfaction driver and competitive advantage for a retailer. Product selection is most frequently dictated by available retail shop floor space. Current methods of managing retail store inventory are inefficient in their use of space because they cannot explicitly allocate space for each and every item in the store. The storage space itself cannot be effectively compacted due to the methods and systems used today to store items, retrieve items, and present inventory to the customer.

Retail stores have been held back by their current methods of presenting products to customers and the lack of technology to link the back room to directly to the customer. The customer (“purchaser”) must endure searching sizable piles of apparel or browsing lengthy racks of crammed hangers in search of the item hoped for. If the purchaser is lucky enough to find the desired item in the proper size and style then the trip to the changing room can also be an unfavorable experience. The purchaser must lug the items to the fitting room and wait for a room to become available. Once inside, and after making the effort to undress and try on the desired items, the customer may discover the need for a different size in the fitting room. This requires a modest customer to call for help or get dressed again, leave the changing room, find a place to store any items to be retained for purchasing, and make a second trip to retrieve a different size, all while lugging any items that could not be stored. If and when the purchaser does make a purchase the wait at the checkout line can be long and embarrassing if the customer's purchase card is declined.

E-commerce apparel customer experiences suffer from the purchaser's inability to physically touch and feel the quality of the item and prevent the purchaser from trying on the item prior to purchasing the item(s). After waiting several days or even weeks for delivery there exists a substantial risk that the item(s) don't fit well or damaged or cannot satisfy the purchaser due to poor quality, improper size, or the wrong item(s) having been sent. Even if a customer gets a full refund, which may take days, they still suffer from the loss of time and the frustration of having to repackage an item suitably for mailing.

There is a better way.

### SUMMARY OF THE INVENTION

The disclosed technology is methods and systems for selling items to be worn that solves these problems through a novel way of processing in-store inventory enabled by a new purchasing experience that applies the efficiency of online shopping to the physical store, using displays with items and indicators, electronic devices with the capability to identify customers and interact with indicators, a large selection of items housed on location that may be delivered to the customer directly into a changing space for trial, and single-action and zero-action purchase.

### BRIEF DESCRIPTION OF THE DRAWINGS

FIG. 1 is a perspective view of a purchasing establishment of the present invention;

FIG. 2 illustrates a display of items with indicators;

FIG. 3 illustrates indicators and conveyance windows in a changing space;

FIG. 4 is a block diagram of the computing system that manages the operations of the purchasing establishment;

FIG. 5 is a flow diagram of a routine that enables single-action or zero-action shopping for recognized customers;

FIG. 6 is a flow diagram of a routine to process purchaser's “Buy” request;

FIG. 7 is a flow diagram of a routine to process purchaser's “Try” request;

FIG. 8 is a flow diagram of a routine to implement purchaser's requests in the fitting room.

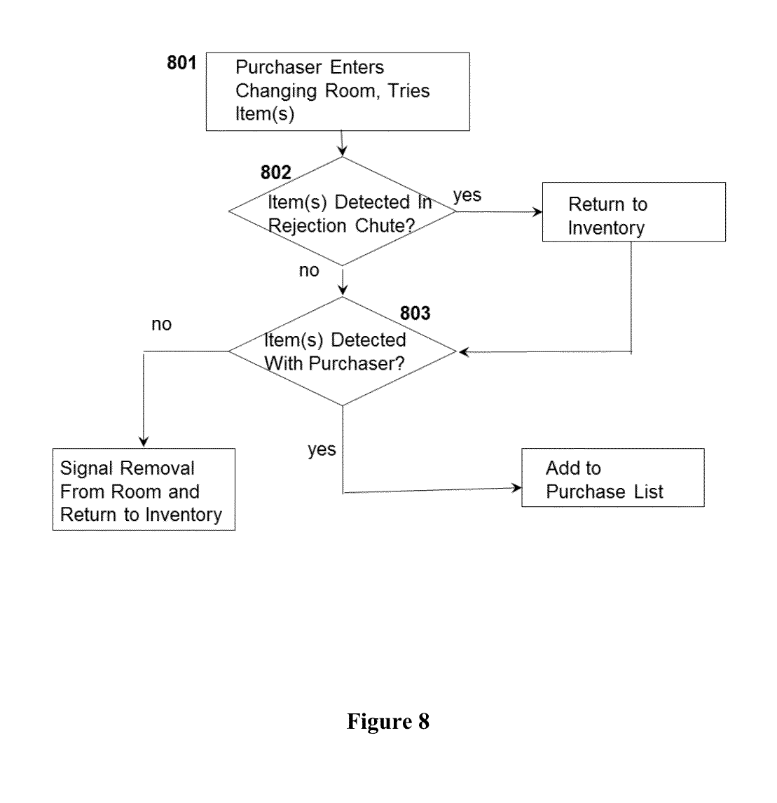

FIG. 9 is a block diagram showing the components of the system for storing, retrieving, and conveying inventory within the service room described in FIG. 1.

FIG. 10 is an illustration of storage locations

FIG. 11 is an illustration of a conveyance device for putting items in the presence of purchasers

FIG. 11a a is an illustration of alternate designs of a conveyance device putting items in the presence of purchasers

FIG. 12 is an illustration of a conveyance device for retrieving items from purchasers

FIG. 12a is an illustration of an alternate conveyance device for retrieving items from purchasers

FIG. 13 is a flow diagram for stowing items in inventory

FIG. 14 is a flow diagram for retrieving items and conveying to customers

FIG. 15 is a flow diagram for conveying items from customers back into inventory

FIG. 16 is an illustration of a checkout indicator

### DETAILED DESCRIPTION OF THE INVENTION

A purchaser, as used in this document, is a person or entity that is able to make a purchase or a rental agreement with any purchasing establishment.

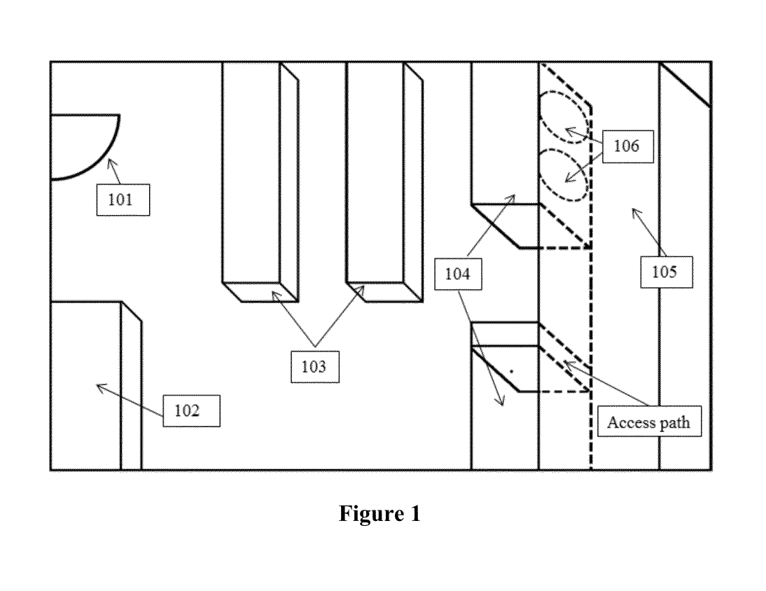

FIG. 1 illustrates a purchasing establishment. The purchasing establishment comprises one or more: displays, items to be worn, indicators (for example, purchase indicators, try indicators, information indicators, checkout indicators, etc.), unique identifiers for different elements in the store (for example, for items to be worn, for electronic devices, for purchasers, for totes, for bags, etc.), changing spaces, request windows, service areas, electronic devices, arrays of readers, and a computing server system.

The purchasing establishment's layout can be rearranged to optimize the amount of time that a purchaser spends in the store.

In FIG. 1 element 101 represents a door and element 102 represents a drop off box for returning items. Element 103 represents displays with items and indicators. The displays' function is to house and present to the purchaser item(s) to be worn. All feature specific items to be worn can contain a unique identifier by electronic or non-electronic means, such as a radio frequency identification tag (“RFID”) or an optical RFID (“OPID”). Unique identifiers may be attached to other elements in the store. Element 104 is a changing space comprised of fitting rooms with conveyance windows and indicators. Fitting rooms have means of providing and securing privacy to the purchaser while trying on feature specific items to be worn and also have means to secure desired items until ready for checkout. Element 105 represents the service room with access to the shop floor. The area can house an inventory of feature specific items to be worn. Element 106 are conveyance windows, allowing the purchaser to deposit item(s) with the service room and enabling the service room to deliver item(s) to the purchaser.

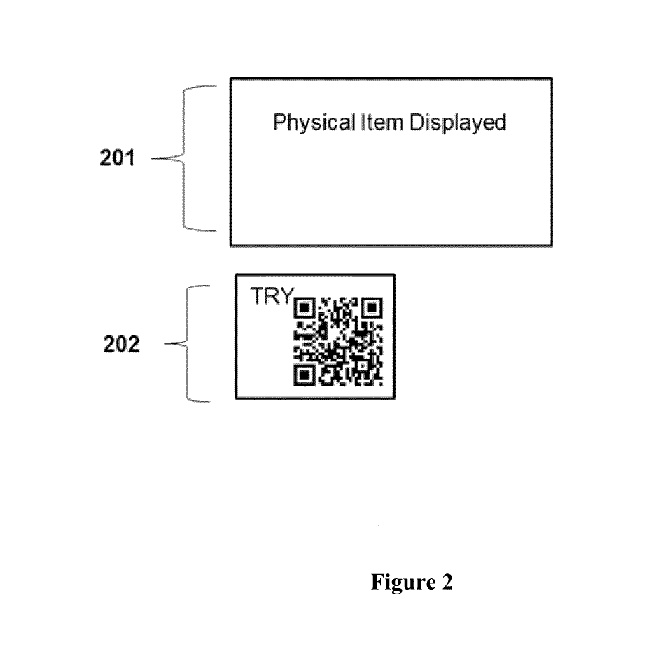

FIG. 2 illustrates item(s) display with indicators in FIG. 1. In the vicinity of, next to, or affixed on or in the item(s) to be worn (element 201) there exist one or more try indicators (element 203). The try indicator is or includes a pattern or sequence of visual or nonvisual information that by itself or with the aid of electronic and/or non-electronic device(s), such as Near Field Communications (“NFC”), Quick Response Codes (“QR codes”) or Braille, informs the purchaser of the option to try on the items(s) to be worn. The display may have other indicators (for example, size, color, checkout, etc.).

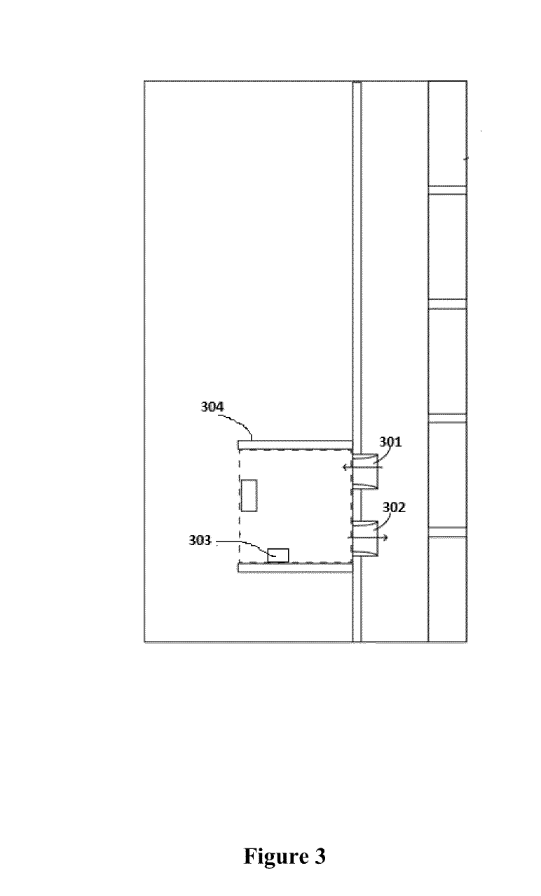

FIG. 3 illustrates indicators and conveyance devices for a fitting room in FIG. 1. In the fitting room (Element 304) there exists one or more conveyance devices (Elements 301 and 302) attached to the conveyance windows described in FIG. 1. The conveyance window may inform the purchaser of an option to place an item in the conveyance device, for example, to return an unwanted item or to request a larger or smaller size of the same item. The conveyance device has means for a one-way or two-way access from the service area to the fitting room to allow purchaser to receive feature specific item(s) from the service area and to return unwanted feature specific items to the service area. Also in the vicinity of there may exist one or more indicators (for example, a checkout indicator, shown as element 303), or a size and/or color indicator. The checkout indicator is or includes a pattern or sequence of visual or nonvisual information that by itself or with the aid of electronic and/or non-electronic device(s), such as NFC, RFID, QR codes or Braille, informs the purchaser of the option to complete his/her purchase.

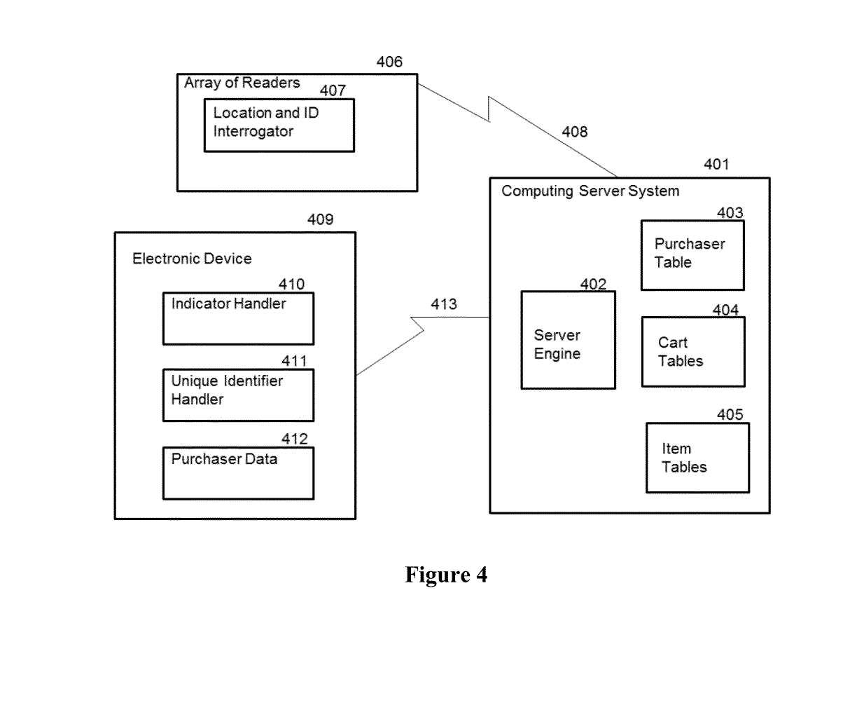

FIG. 4 is a block diagram illustrating the computing system that manages the operations of the purchasing establishment. The computing server system (element 401) consists of one or more computers used to perform services requested by purchasers and the operators of the purchasing establishment. The computing server system may be placed in multiple locations, including but not limited to the purchasing establishment itself, other purchasing establishments, separate dedicated facilities, and cloud computing providers. The computing server system has a Server Engine (element 402) and may include Purchaser Tables (element 403), Cart Tables (element 404) and Item Tables (element 405). Element 406 represents the array(s) of readers with Location and ID Interrogators (element 407). The array(s) of readers' function is to read unique identifiers attached to elements in the store (for example, unique identifiers for item(s) to be worn, electronic devices, toes, bags, etc.) (element 409) and, by means of a wired or wireless connection to the purchasing establishment's computing server system (element 408), communicate the location of the store elements.

Element 409 illustrates electronic device(s). Such devices may be a tablet computer, smartphone, or other miniaturized computing device. Electronic devices may be self-owned by purchasers entering the purchasing establishment. Electronic devices may be owned by the purchasing establishment and loaned to purchasers upon entering the purchasing establishment. The electronic device can have several possible functions, with the possibility of performing any combination of the functions.
One function can be to interpret the pattern or sequence of information actively or passively transmitted by the indicators (Element 410).
Another function can be to interpret the unique identifier on items to be worn (Element 411).
Another function can be to access, communicate with and display communications from the purchasing establishment's computing server system.
Another function can be to transmit a location tracking signal (e.g., GPS, RFID or OPID, Wi-Fi, Bluetooth, and other EM signals) to an array of readers located throughout the purchasing establishment.
Another function can be to signal, including but not limited to audible and vibration signals (to indicate proximity to a purchasing establishment location).
Another function can be to have the means to allow the purchaser to provide and authenticate his or her account (e.g., by scanning a purchaser's unique physical feature of on, or in the purchaser's body or subcutaneous wireless transmitter (RFID tag), by unique electronic tokens stored on the device, or by a conventional username and password) (Element 412).
Another function can be to access a purchaser's account information to complete any sales transaction initiated by the purchaser. The profile may also include purchase history, shipping info, carts (shopping/wish), coupons/rewards, etc. (Element 412).
   Electronic devices may communicate with the Computing Server System (element 413).

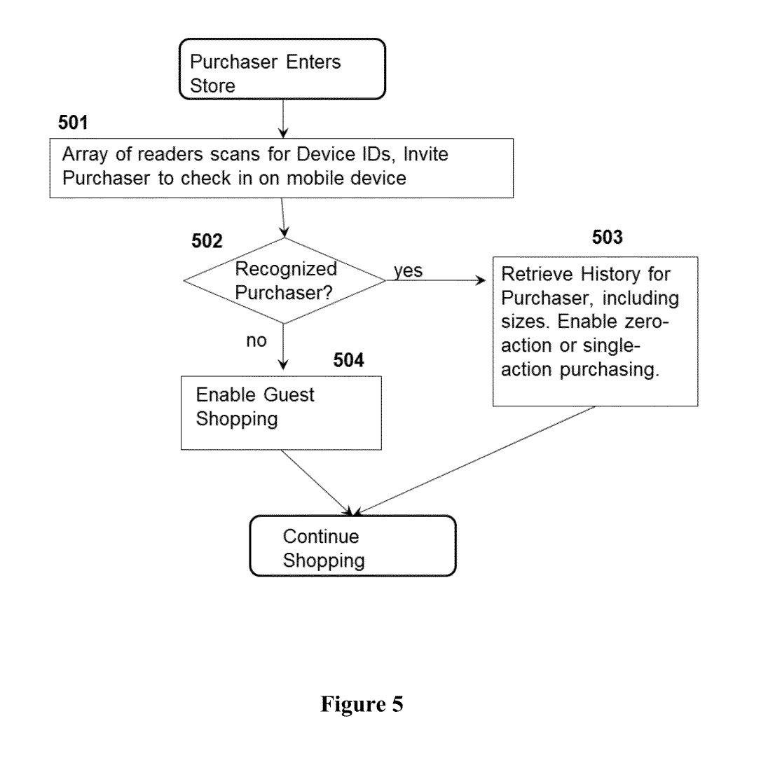

FIG. 5 is a flow diagram of a routine that may be performed upon a purchaser entering the purchasing establishment. Purchasers entering the purchasing establishment may possess self-owned electronic devices. Upon entering a purchasing establishment the purchaser can have the option of being loaned an electronic device.

When a purchaser enters the store, the computing system may attempt to identify the purchaser by scanning for Device IDs and/or offers customers to login to their accounts (element 501). The purchaser's account can be created by the purchaser providing an authenticated unique identifier to the purchasing establishment's computing server system. The identifier may be transmitted through action by the purchaser or with zero-action transmittal automatically from the purchaser's electronic device. Such unique identifiers may include, but are not limited to, conventional username/password combinations, social media ids, email ids, and electronic tokens stored on the electronic device. The identification of the purchaser is depicted in element 501 and 502. The server system may authenticate the unique id using standard authentication methods appropriate to the particular id provided, and assign an account. Once the account is created various types of data would then be collected. The purchaser's account may include information such as: body sizes, body dimensions, purchase history, purchasing accounts, style preferences, medical information (e.g., for diabetic socks or orthopedic devices), sport activities, social media, significant holidays (e.g., anniversary, prom, wedding, honeymoon or vacation), etc. (element 503).

The system enables single-action and zero-action shopping for a recognized purchaser and may create a guest account for non-recognized purchaser. In a preferred embodiment of the invention, zero-action purchase or rejection of item(s) can be accomplished by a purchaser as a by-product of their location in the purchasing establishment.

Two types of purchasing of item(s) to be worn are envisioned: one type offers the quickest experience of buying item(s) without trying them on; the other offers purchasers to try on item(s) of various sizes before purchasing them. The purchaser have the option of combining those experiences and buying some item(s) without trying them on, while buying others after trying them on.

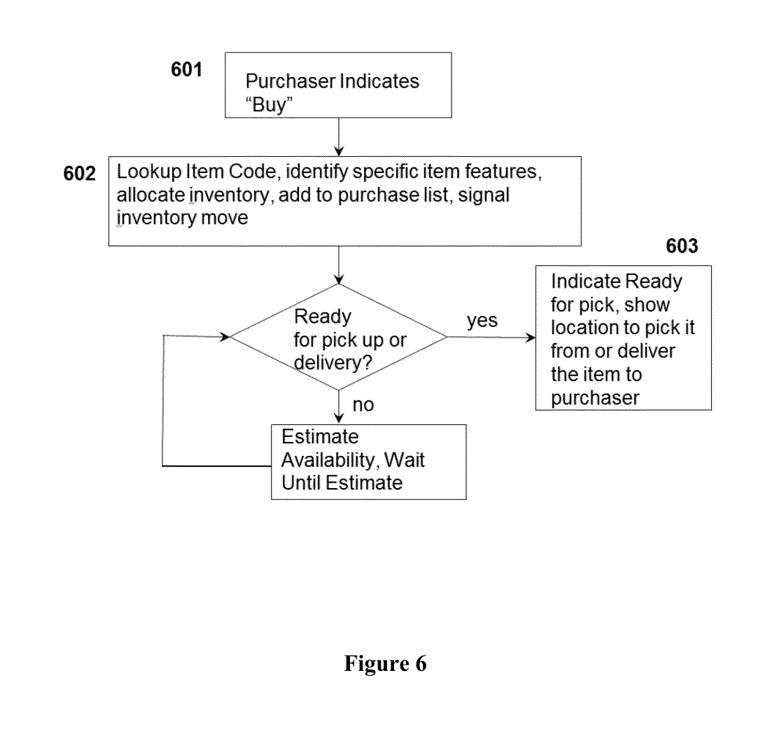

Buying Without Trying Items On (FIG. 6)

The purchaser can search the displays and arrive at an item of interest.

If the purchaser seeks to acquire more information about an item in a display he or she may interact with the information indicator to get more information about the item. For example, she/he can use the loaned electronic device, an electronic device next to the item, or his/her own electronic device, if similarly capable, to scan the information indicator. Once scanned the purchasing establishment's computing system can retrieve information about the scanned item and present the information to the purchaser on the electronic device.

If this purchaser is recognized by the system and decides to purchase the item(s) he/she can indicate so by taking the item off the shelf.

Another way is, if this purchaser decides to purchase the item(s) he/she can indicate so by interacting with the purchase indicator (element 601). One skilled in the art would appreciate that the interaction of purchasers with indicators may be implemented using various techniques. For example, the purchaser may scan the indicator with the electronic device or touch the indicator.

If the purchaser is identified and has historical purchasing data then the purchaser's data (for example, preferred size, style, color, etc.) can be retrieved from the purchasing establishment's computing system. If the feature specific items corresponding to an item's scanned purchase indicator are in stock then the computing system can charge the payment method on file and complete the ordering transaction.

Purchaser may have an option to pick the feature specific item off the store shelf, or at designated counter, or have the item brought to the purchaser by store personnel or delivered at a later time to purchaser's preferred mailing address.

If the purchaser's account lacks historical purchasing data required for the feature specific item to be purchased then the purchaser will be prompted for more specific features of the desired item (for example, the purchaser's dimensions, size, preferred style, color, etc.). This data can be stored in the purchaser's account in the purchasing establishment's computing system.

Once a purchaser has indicated the desired item(s) and specified the desired features of the item the purchasing establishment's computing system can search for the availability of the feature specific item(s) in inventory.

If the feature specific items corresponding to an item's scanned purchase indicator are in stock then as the purchase indicator is scanned they can be virtually added into a purchaser's account's electronic shopping cart. If the item is available on the shelf the system may indicate so to the purchaser. If it is only available in the service room, the system signals to gather the item in the service area. If the feature specific item is only available in a purchasing establishment other than the one currently occupied by the purchaser, the purchaser is able to add the feature item to his or her electronic shopping cart and have the item delivered at a later time to the purchaser's preferred mailing address.

If the feature specific items are not in stock then the electronic system may suggest an alternative feature specific items that are in stock to the purchaser. The purchaser may be notified when the item(s) become available or are in stock. The above steps are depicted in element 602.

If the purchaser has been recognized by the system, this may conclude the purchasing transaction. The computing system can charge the payment method on file. Alternatively the purchaser may select a checkout feature on the electronic device or scan a checkout indicator. The computer system can complete the transaction by prompting the purchaser for verification of payment information. If the purchaser is a first time purchaser the computer system can ask for payment information and complete the purchase transaction. Once the transaction is complete the system may inform the purchaser where to pick purchased items, including, but not limited to the store shelf, pickup counter or designate tote. The item(s) could also be delivered to the purchaser from the service area or shipped to his/her preferred mailing address. The above steps are depicted in element 603.

If the purchaser is finished shopping then any loaned electronic device is returned and the purchaser ends his shopping experience. If the purchaser is not finished shopping then his or her shopping experience can continue by searching the displays for item(s) of interest or by accepting to purchase alternate feature specific item(s) that are in stock.

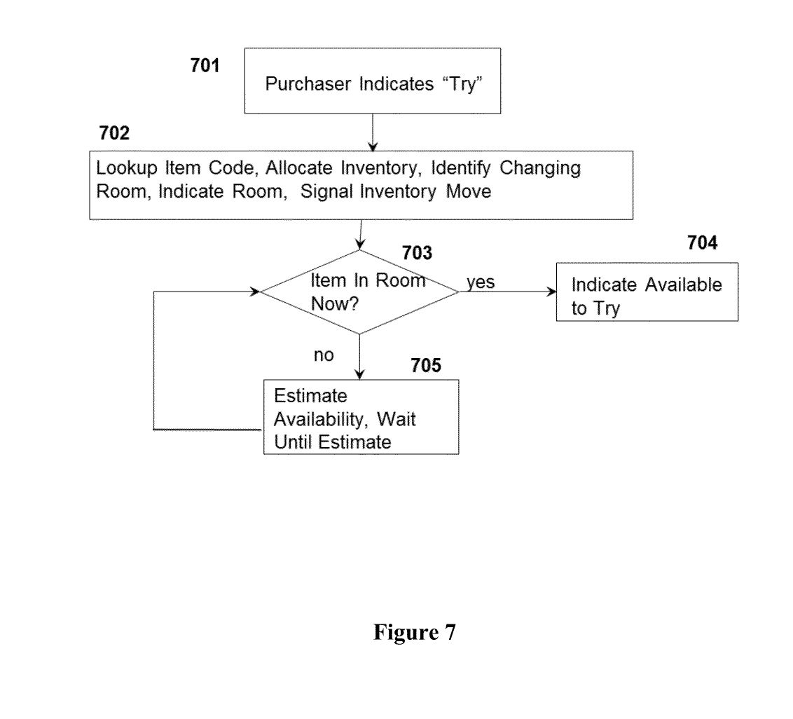

Buying With Trying Items On (FIG. 7).

Another type of purchaser can prolong the shopping experience beyond the quickest possible experience. This type of purchaser can search the displays and arrive at an item of interest.

If the purchaser desires to try on a feature specific item he or she may indicate so. For example, the purchaser may interact with the try indicator, for example, by scanning the try indicator using electronic device. Another way is to move the desired item. Another way it to select to try the desired item using electronic device (section 701).

If the purchaser is recognized and has historical purchasing data then this data can be retrieved from the purchasing establishment's computing system. If the purchaser is recognized as a Guest purchaser or if a first time purchaser then the electronic device can prompt him or her for more specific features of the item that are desired, such as size, color, etc.

The history of feature specific item(s) that purchasers select to try on can be recorded and preserved in the purchasing establishment's computing system.

Once the purchasing establishment's computing system knows that the purchaser wants to try on feature specific item, the computing system can search for the availability of the feature specific item(s) in inventory (element 702).

If the feature specific item is not in stock then the electronic device can notify the purchaser that the feature specific item(s) are unavailable or on back order. Alternative feature specific items that are in stock may be suggested to the purchaser. The purchaser may be notified when the item(s) become available or are in stock.

If the feature specific item is in stock, the computing system can prompt a reservation of the purchasing establishment's fitting room and communicate to the purchaser (for example, via the electronic device), which of the fitting rooms is reserved for his or her use (elements 703, 704, 705). The system may also virtually add the feature specific item to an electronic shopping cart. While feature specific items are being virtually added to the electronic shopping cart they can be gathered in the service area.

Once the purchaser is finished selecting item(s) to try on, the purchaser may so indicate by entering a vacant changing space or by selecting a feature on the electronic device or by interacting with an indicator. If the purchaser uses the electronic device to indicate readiness to try on feature specific items the electronic device can direct the purchaser to one of the purchasing establishment's enclosed changing spaces (element 704). Feature specific items can then be moved from the service area into the changing space reserved for the purchaser. After the purchaser enters the reserved changing space the purchaser may secure their privacy (i.e., close a door or curtain), and try on the feature specific item(s) to be worn, shown in element 801.

If the purchaser declines to purchase the feature specific item(s) the purchaser may return the unwanted item(s) through the conveyance window. The establishment computing system may detect unwanted items (for example, from a signal from the array of readers) and virtually remove the item from purchaser's reserve cart. Another way is for the purchaser to leave the unwanted items in the fitting room. Element 802 shows this step.

Requesting to Try On a New Feature Specific Item (For Example, Different Size).

If the purchaser desires to select new feature specific items to try on the purchaser may choose to remain in the changing room and continue to browse the purchasing establishment's items on the electronic device and request that those items be brought to the changing room. The requested items may be gathered in the service area and delivered to the purchaser fitting room.

If the purchaser decides to purchase the item, element 803 depicts a preferred embodiment of the disclosed technology where the purchaser can simply leave the changing space with the item(s) triggering a zero-action purchase.

The purchaser may also complete the purchasing transaction by interacting with the Checkout indicator or by using Checkout routine on electronic device. Once the purchasing transaction is completed by the computing system, the purchaser may leave the purchasing establishment with the item(s).

The purchaser may also choose to have the feature specific item(s) packaged. Packaging may be performed by the purchaser or by the purchasing establishment. For example, the purchaser may request packaging by placing the item(s) into the Packaging request window. Another way is, the purchaser may indicate a request for packaging on the electronic device.

If the purchaser is finished shopping then any loaned electronic device is returned and the purchaser ends his or her shopping experience. If the purchaser is not finished shopping then his or her shopping experience can continue by searching the displays for item(s) of interest or by accepting to purchase alternate feature specific item(s) that are in stock.

Returning Unwanted Items

Each feature specific item that was purchased can have included in or on it an identifier that uniquely identifies the feature specific item (an RFID). When a purchaser enters the sensing range of the array of readers the unique identifier can communicate with the purchasing establishments computing system and can identify the item and which account was used to purchase the item. The purchaser then deposits the item to be returned into a return area and leaves. An employee can then examine the garment for conditions that would void eligibility for return. If the garment is eligible for return then the purchasers account can be credited the purchase price.

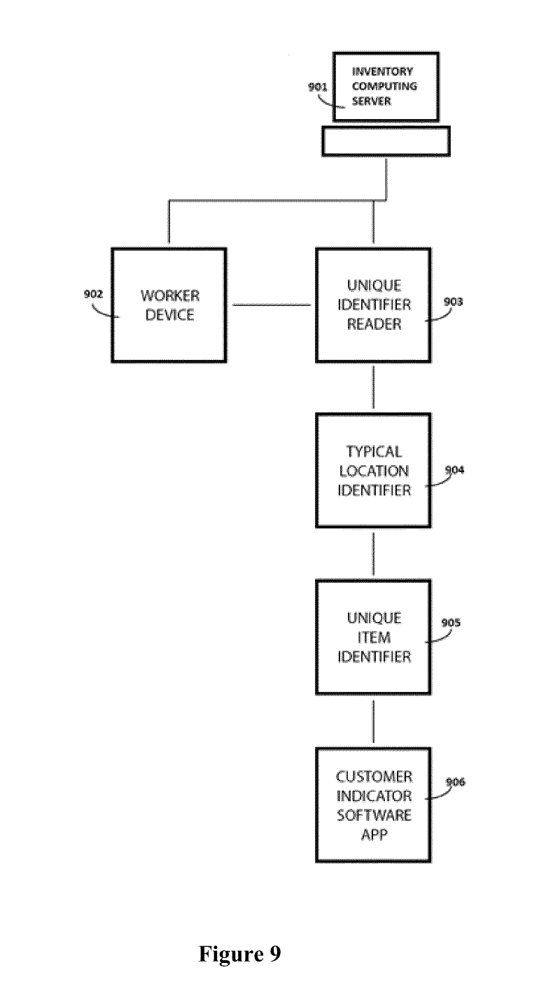

FIG. 9 is a block diagram showing the components of the system for storing, retrieving, and conveying inventory within the service room described in FIG. 1. Element 901 is the inventory computing server system. Element 902 is a worker device connected to the inventory computing server system. Element 903 is a unique identifier reader which detects customer deposit of items in a conveyance device. Element 904 is a typical location unique identifier affixed to or in the vicinity of a location (for example, a compacted storage location, conveyance device, or customer examination location). Element 905 is a unique identifier for an item. Element 906 is a typical customer indicator software application, running on either a store-provided indicator device or a device provided by the customer (such as a smartphone or computer tablet). Customer indicator software applications are used to summon inventory into the presence of the customer.

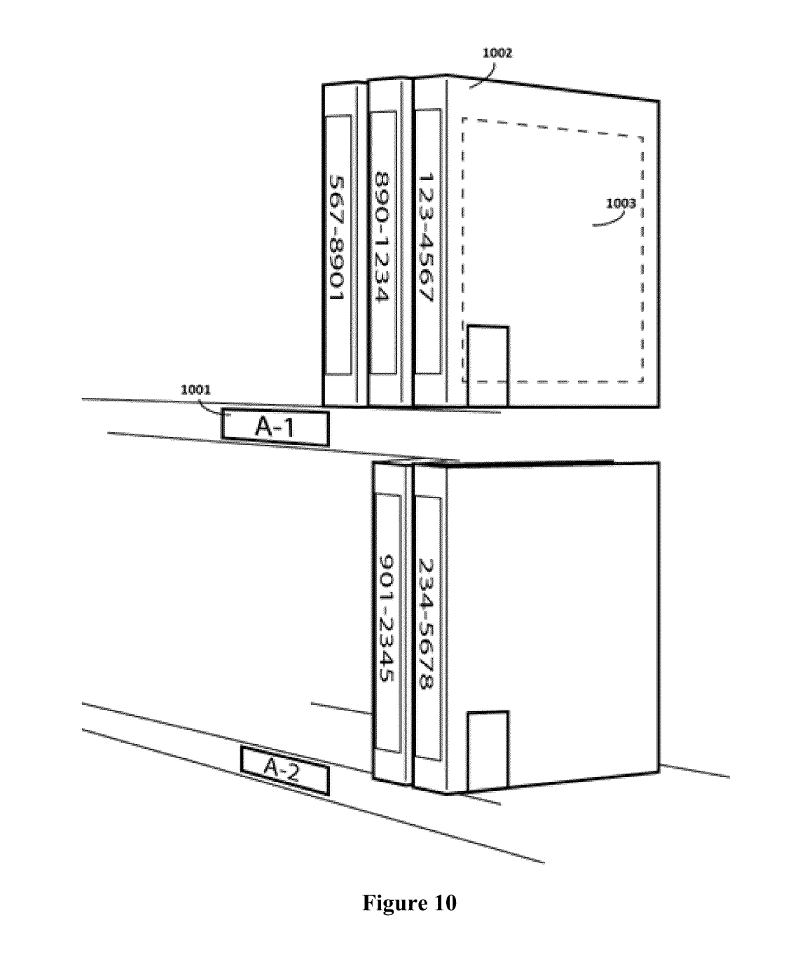

FIG. 10 illustrates the compacted storage locations. Element 1001 is typical location. Element 1002 is an inventory container within that location. Element 1003 is an item within the inventory container. The inventory location has an affixed visual indicator accompanied by an RFID tag to allow a worker to easily identify the location. The inventory container within that location also has an affixed visual indicator and an RFID tag which allows the worker to select a specific item from the inventory container. In a preferred embodiment of the disclosed technology, inventory containers comprise a plurality of rectangular covers joined by a spine wherein an item may be stored. One skilled in the art would appreciate that the cover may be implemented using different shapes. For example, it could be in the shape of a book cover or a rectangular box with cutouts to allow access.

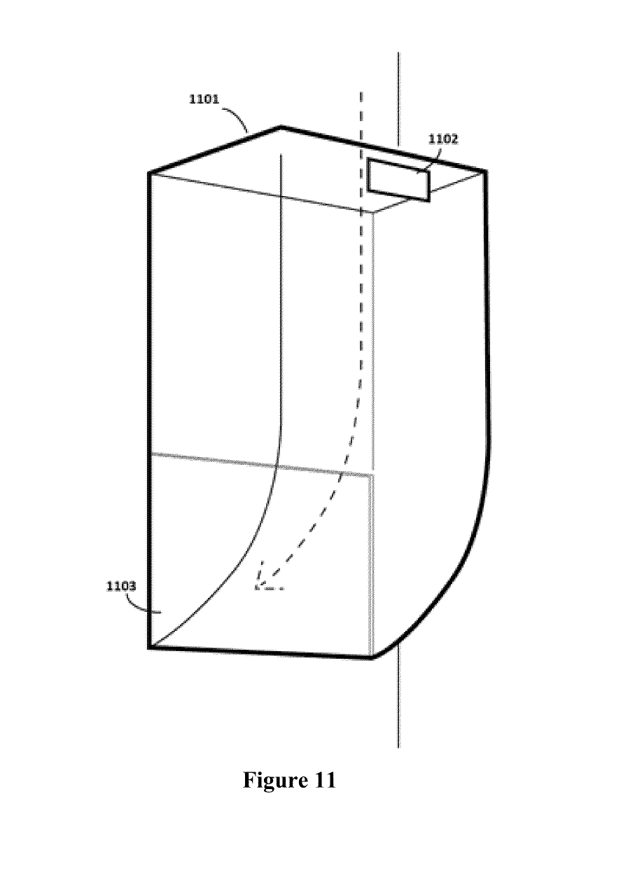

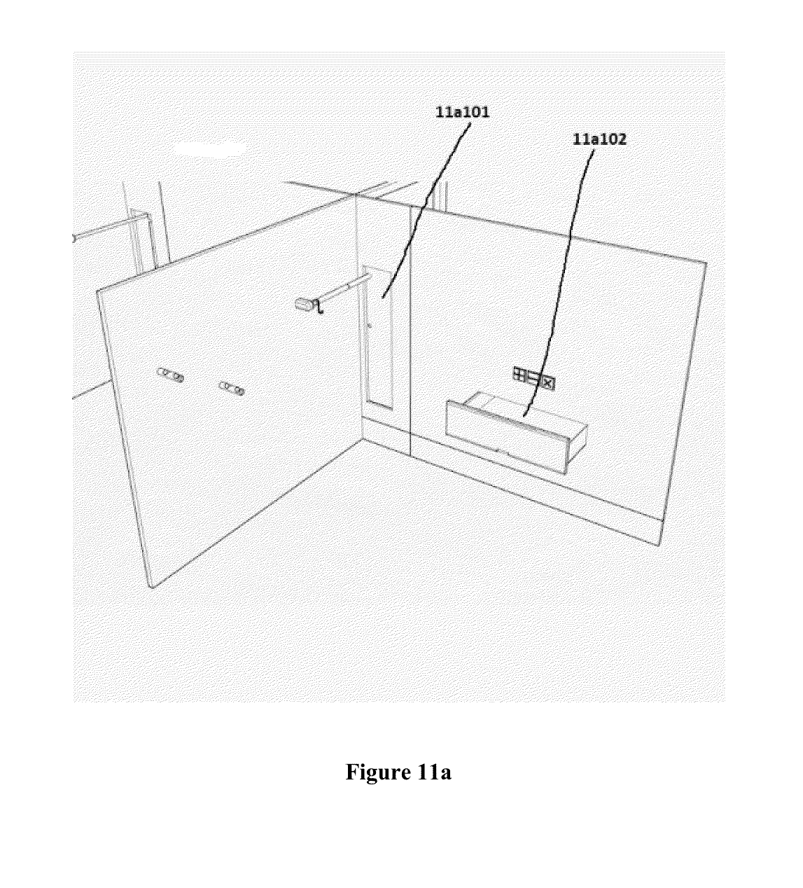

FIG. 11 illustrates the conveyance device of FIG. 1 used to put items in the presence of customers. Element 1101 is the entry point of the device into which items may be placed. Element 1102 is the unique identifier for the conveyance device. Element 1103 is the exit point of the device where items will enter the presence of customers. FIG. 11a illustrates that the conveyance device could be constructed in many different ways, including a door or a sliding bar. Element 11a101 is a door and sliding bar for presenting items on hangers. Element 11a102 is a drawer presenting items within.

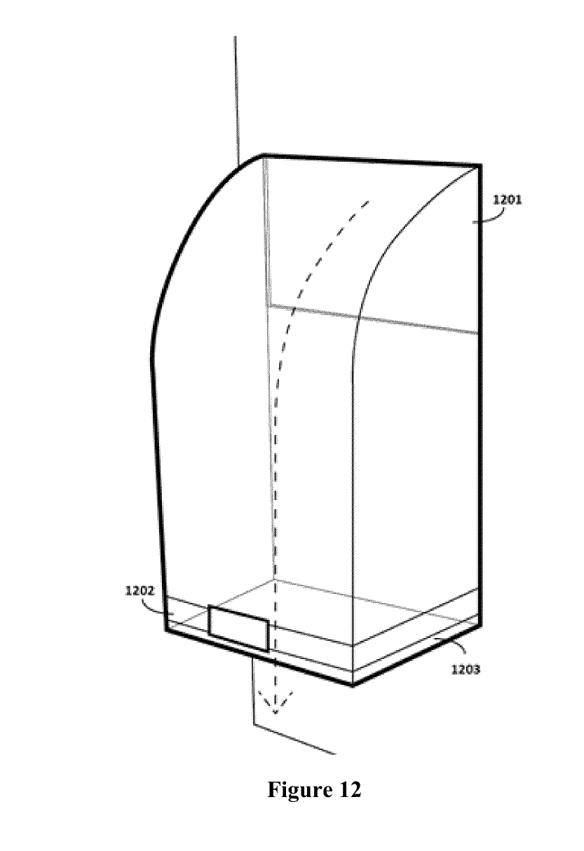

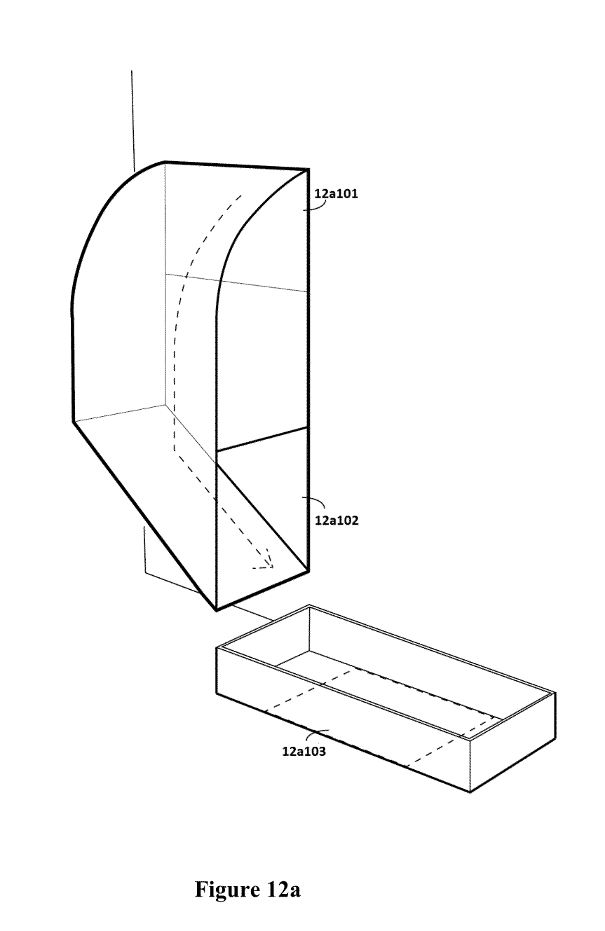

FIG. 12 illustrates a conveyance device used to retrieve items from customers and initiate re-stowing into compacted inventory. Element 1201 is the entry point where customers place items into the conveyance device. Element 1202 is a unique identifier reader within the conveyance device which detects the presence of items. Element 1203 is the exit point for items deposited into the conveyance device. FIG. 12a illustrates an embodiment of a conveyance device. Element 12a01 is a gravity operated chute which receives items deposited by customers. Element 12a02 is a redirection bend within the chute. Element 12a03 is a preferred embodiment of the invention comprising an RFID reading antenna placed horizontally at the outlet of the chute.

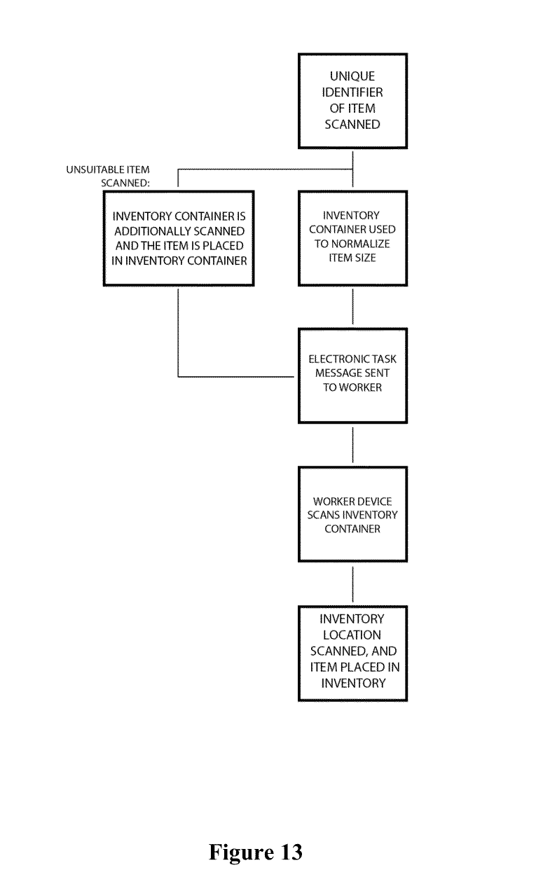

Receiving Inventory (FIG. 13)

The unique identifier of an item is scanned. If the item itself is unsuitable to be its own inventory container for direct placement in a compacted inventory container, an inventory container is additionally scanned and the item is placed in the inventory container. The inventory container is used to normalize the size of the item where items have shape inconvenient for compacting (for example, with apparel items). After scanning the item and, if needed, the inventory container, an electronic task message is sent to the worker device to direct placement of the inventory container in a compacted inventory container. The worker device scans the inventory container and the compact inventory location receiving the container to confirm the correct placement of the inventory.

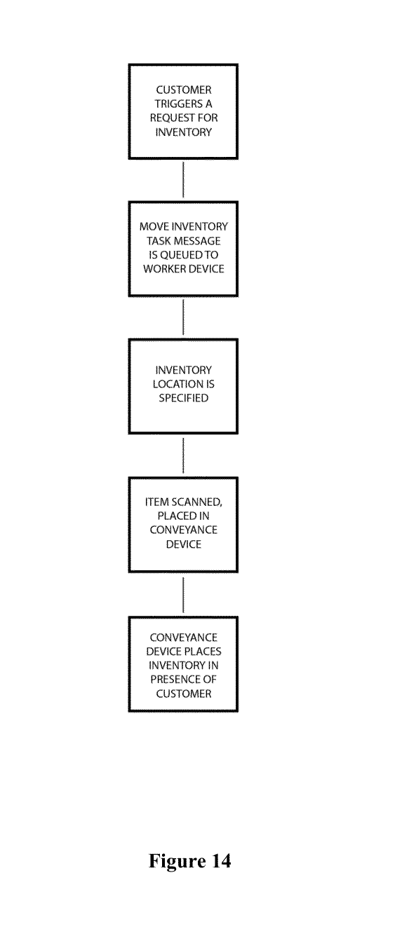

Retrieving an Item (FIG. 14)

A customer triggers a request for inventory either by optically or electronically scanning a display item tag or by directly manipulating the purchaser indicator software application. In either case, a move inventory task message is queued to worker devices, specifying the compacted inventory container holding the inventory container for an item matching the item requested by the purchaser. A worker device de-queues the message and directs removal of the item from the inventory container. The item is scanned and placed in or on the conveyance device, which is also scanned to indicate a change of location for the item. The conveyance device places the item in the presence of the customer.

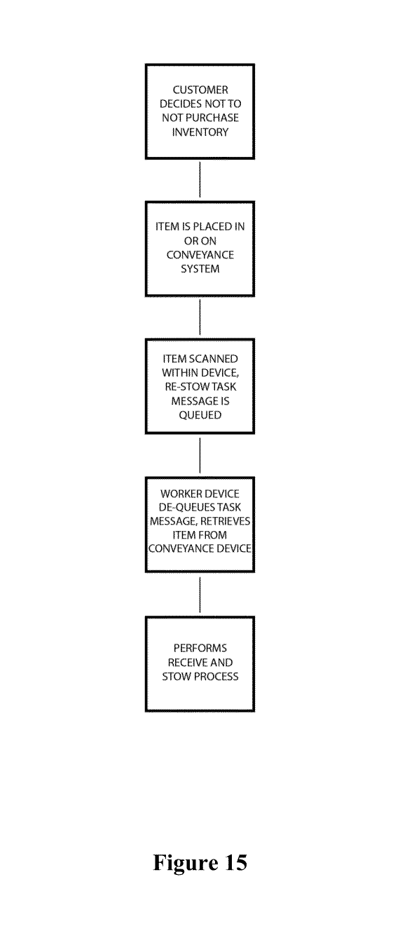

Re-stowing an item into inventory (FIG. 15). A customer who decides not to purchase an item places the item in or on a conveyance device. The item is scanned within the device and a re-stow task message is queued. A worker device de-queues the task message directing a shop floor worker to retrieve the item from the conveyance device and perform the receive and stow process described in FIG. 6.

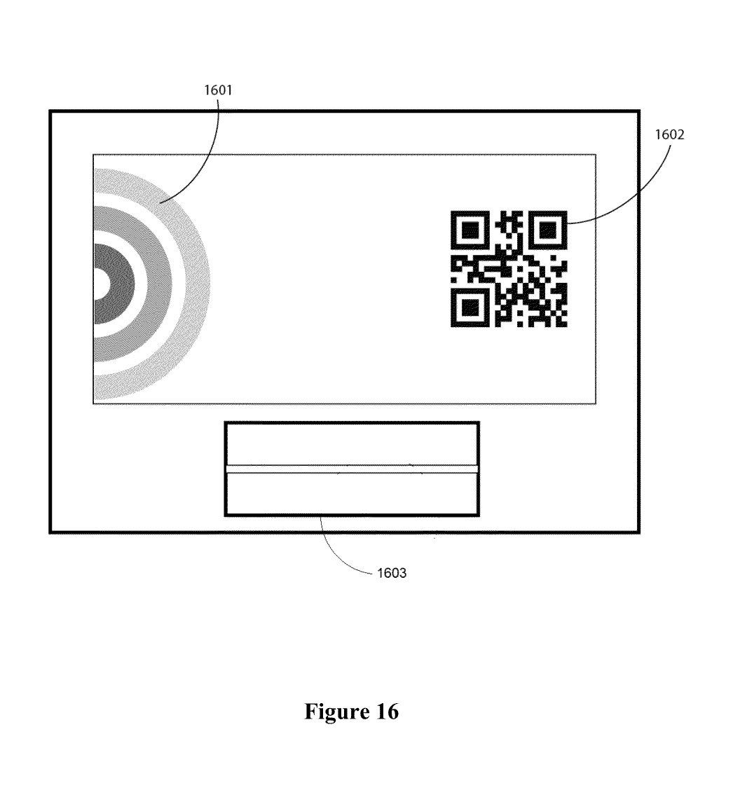

FIG. 16 illustrates a checkout indicator offering a choice of scanning by RFID (element 1601) or scanning by QR code (element 1602). A purchaser with items in his or her electronic shopping cart scans the checkout indicator with an electronic device. The scan causes the contents of the electronic shopping cart to be displayed on the checkout indicator's display screen and enables the purchaser to associate a payment instrument (for example a credit card, debit card, or smartphone) to the checkout transaction by interaction with the checkout indicator's payment instrument reader (element 1603). The interaction may take the form of touching, tapping, swiping or otherwise bringing the payment instrument into proximity with the checkout indicator.

While the foregoing written description of the invention enables one of ordinary skill to make and use what is considered presently to be the best mode thereof, those of ordinary skill can understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

We claim:

1. A method of selling items to be worn in a purchasing establishment comprising displays, items to be worn, indicators (for example, purchase indicators, try indicators, information indicators, checkout indicators, etc.), unique identifiers for different elements in the store (for example, for items to be worn, for electronic devices, for purchasers, for totes, for bags, etc.), changing spaces, electronic devices, arrays of readers, and a computing server system;

2. The method in claim 1 comprising an electronic device used by purchasers to scan a try indicator to cause one or more feature specific items to be moved from a storage location (for example, a service room) to a shop floor location directly accessible to the purchaser (for example, a changing space, shoe fitting seat, jewelry counter, etc.);

3. The method in claim 2 comprising an electronic device scanning an RFID tag;

4. The method in claim 2 comprising an electronic device scanning a QR code;

5. The method in claim 3 comprising an electronic device scanning an RFID tag using the; ISO 15693 standard;

6. The method in claim 3 comprising an electronic device scanning an RFID tag using the ISO 14443 standard;

7. The method in claim 1 comprising an electronic device used by purchasers to scan a try indicator to cause one or more feature specific items to be added to the purchaser's electronic shopping cart;

8. The method in claim 7 comprising a zero-action purchase wherein the feature specific items remaining in an electronic shopping cart are automatically charged to the purchaser's payment instrument;

9. The method in claim 7 comprising a single-action checkout triggered by electronic device scanning means wherein items in the purchasers shopping cart are charged to the purchaser's payment instrument;

10. The method in claim 1 comprising an array of readers which sense a purchaser's return of unwanted items with means to remove them from the purchaser's electronic reserve cart;

11. A method of storing and retrieving items to be worn, within a purchasing establishment, comprising compacted inventory locations, inventory containers, unique identifiers (for example, inventory location identifiers and item identifiers), worker devices, conveyance devices, identifier readers, and a computing server system;

12. The unique identifiers in claim 11 comprising RFID tags using the ISO 15693 standard;

13. The unique identifiers in claim 11 comprising RFID tags using the ISO 14443 standard;

14. The conveyance devices in claim 11 comprising a vertical chute into which customers deposit items having means to uniquely identify each item deposited;

15. The conveyance devices in claim 14 comprising one or more horizontal RFID reading antenna(s);

16. The conveyance devices in claim 14 comprising one or more roughly rectangular RFID reading antenna(s) with a shortest side dimension of between 15 and 30 centimeters and a longest side dimension between 30 and 50 centimeters positioned near the chute's exit point in such a way that items fall within the rectangle;

17. The inventory container in claim 11 comprising a visual identifier affixed to its surface where the identifier is paired by a computer system to the RFID tag affixed to the inventory container;

18. The worker device in claim 11 comprising a Near Field Communications (NFC)-enabled tablet computer and software capable of reading ISO 15693 tags and receiving and processing messages from a computing server system directing the movement of items to be worn within a purchasing establishment;

19. The worker device in claim 11 comprising a Near Field Communications (NFC)-enabled tablet computer and software capable of reading ISO 14443 tags and receiving and processing messages from a computing server system directing the movement of items within a retail store; and

20. Inventory containers comprising a plurality of rectangular covers joined by a spine having an affixed NFC-readable tag wherein an item may be stored.
